(19) United States
(12) Patent Application Publication
(10) Pub. No.: US 2020/0033504 A1
(43) Pub. Date: Jan. 30, 2020

(54) HYPOTHESIS TESTING SYSTEMS FOR DETECTION OF HIDDEN FEATURES

(71) Applicant: QPX Edge Ltd.

(72) Inventors: Ilan Naor, Brookline, MA (US); Yair Frastai, Brookline, MA (US); Noam Alon, New York, NY (US)

(21) Appl. No.: 16/045,500

(22) Filed: Jul. 25, 2018

(51) Int. Cl. G01V 99/00

(52) U.S. Cl. CPC G01V 99/005

(57) ABSTRACT

Hypothesis testing systems for detection of hidden features, for example in geology, are provided. In various embodiments, a plurality of rules is read. The rules relate a plurality of observable phenomena to a hidden feature of interest. Based on the feature of interest and the plurality of rules, a plurality of scenarios is generated. Each scenario specifies a combination of observations sufficient to indicate presence of the hidden feature of interest. The plurality of scenarios is ranked based on a score associated with each of the observations. A plurality of observations is received. The plurality of scenarios is compared to the plurality of observations. Those of the plurality of scenarios inconsistent with the plurality of observations are discarded Additional observations are received until at least one of the plurality of scenarios is fully supported.

### BACKGROUND

Embodiments of the present disclosure relate to goal-seeking or back-solving algorithms, and more specifically, to hypothesis testing systems for detection of hidden features, for example in geology.

### BRIEF SUMMARY

According to embodiments of the present disclosure, methods of and computer program products for detection of a hidden feature of interest are provided. A plurality of rules is read. The rules relate a plurality of observable phenomena to a hidden feature of interest. Based on the feature of interest and the plurality of rules, a plurality of scenarios is generated. Each scenario specifies a combination of observations sufficient to indicate presence of the hidden feature of interest. The plurality of scenarios is ranked based on a score associated with each of the observations. A plurality of observations is received. The plurality of scenarios is compared to the plurality of observations. Those of the plurality of scenarios inconsistent with the plurality of observations are discarded Additional observations are received until at least one of the plurality of scenarios is fully supported.

### BRIEF DESCRIPTION OF THE SEVERAL VIEWS OF THE DRAWINGS

FIG. 1 illustrates a taxonomy according to embodiments of the present disclosure.

FIG. 2 illustrates an exemplary feature profile according to embodiments of the present disclosure.

FIG. 3 illustrates a hypothesis testing process according to embodiments of the present disclosure.

FIG. 4 illustrates a method for preparing gates for detection of a hidden feature of interest according to embodiments of the present disclosure.

FIG. 5 illustrates a method for detection of a hidden feature of interest according to embodiments of the present disclosure.

FIG. 6 depicts a computing node according to an embodiment of the present disclosure.

### DETAILED DESCRIPTION

In general, a goal-seeking or back-solving algorithm pertains to determining a set of unknown inputs to a process that would result in a set of known outputs. A variety of problems may be framed as a goal-seeking problem.

For example, in the context of mineral exploration, a variety of outputs of a geological process may be readily measurable, while the underlying cause may not. Likewise, certain features of interest may not be readily observable, while features sharing a common underlying cause may be apparent. In particular, the presence or absence of a hidden feature of interest may be indicated by a variety of superficial features. Working from the superficial features, it may not be apparent what hidden features are present, or in what combination. Moreover, a given set of superficial features may correspond to multiple hidden causes, making discernment of a root cause or a given feature of interest difficult.

Collection of further data in the geological context is particularly expensive, and so accurate and early differentiation between multiple underlying scenarios is critical to successful mineral exploration. At the targeting stage of the mineral exploration process, companies invest huge amount of resources in data collection, using various collection and analysis methods, to determine where a hidden mineral deposit is located.

Certain superficial geological features are well understood based on geological theories. However, inference from these features to arrive at a hidden feature is not done systematically. Using alternative methods, there is no way to screen the large number of relevant elements that can be found in the field and the large number of possible manifestations of those elements in different contexts and settings. Moreover, there are many collection and analysis methods available, most of which are instrumental and indirect, that provide various indications of geological phenomena to different levels of accuracy, resolution, and confidence. The amount of relevant features combined with the multiplicity of exploration methods produce an overwhelming volume of possible outcomes and combinations, each of a different nature and quality, that makes it impossible to effectively and efficiently arrive at a determination of hidden features.

One alternative approach to mineral exploration is to exhaustively apply all available methods to locate a list of favorable geological features. In practice, this approach is limited by cost, including the cost of access to land for exploration. In addition, such methods are prone to individual interpretation, leading to inconsistent results based on the same data.

In a checklist approach, the primary consideration for determining if an area is harbors a hidden feature of interest is the number of elements from the list that are found in an area and their intensity. For example, an area in which 6 features were found and 3 of them are strong (e.g., intense or large) will be prioritize over an area in which only 4 features were found and only one of them is strong. An exemplary list may consist of 8-15 items that represent about 10 additional hidden items behind each listed feature. These hidden items correspond to the different ways in which each feature can manifest in actual geological settings, and thus correspond to a geological mechanism or other hidden feature.

In a checklist approach, there is no method for determining if a minimum set of necessary components have been located, and this when to stop investigation. In particular, where the objective of an investigation is merely to find as many favorable elements as possible, it is natural to continue the collection without limit. This lack of objective minimal criteria for evidence collection leads to errors, waste of time and money, and poorly quantified decisions.

To address these and other shortcomings of alternative approaches, the present disclosure provides systems and methods for back-solving that enable efficient information gathering, analysis, and decision-making. Although several examples in the mineral exploration context are provided herein, it will be appreciated that the present disclosure is applicable to a variety of context in which there is a need to make efficient inference about hidden features on the basis of limited observation. In particular, the present disclosure is generally applicable to search, where there is a need to reach a conclusion to a predetermined certainty while minimizing search time or cost.

As used herein, a Factor refers to a hidden feature or process that coincides with a given hidden feature. For example, a factor may be a critical geological process that must have occurred to generate a particular mineral system of interest.

As used herein, an Indicator is a directly or indirectly observable feature that may provide supporting evidence for the present or absence of a given Factor. For example, an indicator may be a geological feature that is discoverable or inferable through observation and that provides evidence for a Factor. The way in which an Indicator appears in nature is affected by its environment, conditions, and overall setting. Accordingly, many possible Manifestations of an Indicator must be considered to conclude that an indicator is present and arrive at a high quality decision.

As used herein, a Manifestation refers to a set of potential evidence that corresponds to the expression of a particular Indicator in nature. For example, a particular soil test result may provide evidence for the presence of a certain mineral assemblage in turn indicates the existence of an alteration that is related to a feature of interest.

As used herein, a Level refers to the favorability level of a manifestations. In various embodiments, this may be based on intensity, size, volume, or other characteristics that correlate with the value or favorability of a hidden feature or target. In some embodiments, the Level for each Manifestation may be a continuous value. In some embodiments, the Level may be a discrete value, for example, I, II, or III. In some embodiments, the level is a label selected from a predetermined set of labels. The assignment of a Level enables matching between the attributes of each observed phenomenon and its favorability level. This in turn allows determination of the confidence and favorability of the feature of interest. In various embodiments, favorability may reflect the volume, intensity, or concentration of the feature of interest. In this way, favorability may coincide with the economic value of the feature of interest, for example reflecting mineral grade.

As used herein, a Profile refers to a set of indicators that correspond to a given hypothetical hidden feature or features. A set of Profiles reflects a set of hypotheses to be tested.

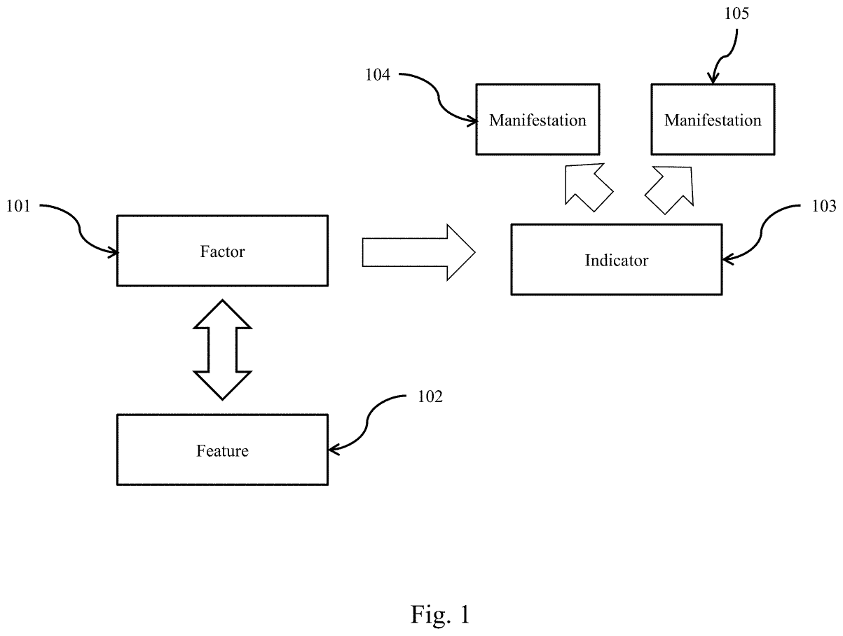

Referring to FIG. 1, the relationship between this terminology is illustrated. A Factor 101 is a feature or process that coincides with hidden feature 102, for example a hidden mineral deposit. Factor 101 leads to one or more Indicator 103, which may be observable directly or indirectly. Depending on the particular context in which the Indicator appears, it may be observed indirectly through one or more Manifestation 104 . . . 105.

In various embodiments, a gating algorithm is applied to evaluate a plurality of profiles against manifestations and Indicators to determine the presence of a hidden feature of interest. In a Gate/Key or Gate Evaluation process according to the present disclosure, weighted confidence values are computed for individual Indicator. These confidence values contribute to individual gates. Once each gate reaches confidence threshold level, they are cleared, allowing progression towards validation of a given hypothesis. In a geological context, the hypothesis may correspond to the presence of a hidden high-value resource, such as a mineral deposit.

By applying the gating systems and methods described herein, hypothesis testing against observed phenomena is streamlined. Moreover, by framing the objective of evidence gathering in terms of observing a limited set of evidence and thereby clearing a predetermined gate, the resource requirements for identification of a hidden feature are bounded.

In the geological context, each gate corresponds to a specific combination of favorable geological features that are a subset of the target Profile and are sufficient to demonstrate the existence and the location of a mineral deposit target. Each Gate corresponds to different combinations of geological features and has different quantifiable qualities. Each gate also contains the minimum required Indications needed to support a decision. This way, the collection during targeting is constrained by the minimum combination of features required to conclude the present of a feature of interest, rather than an open-end approach trying to gather as much as possible.

Based on the hypotheses to be tested, the necessary additional information may be determined through filtering the plurality of Profiles to determine those that are still viable. Collection efforts may thus be guided, and analysis efforts may be focused on addressing the features unaccounted for in any gates that remain viable. For example, in an area in which 3 geological features were already found, further investigation may focus solely on finding the missing possible features that are needed to complete one of the pre-defined Profile combinations. This increases the efficiency of the targeting stage, refocusing investigation on the minimum required to pass the gate and arrive at validation of a hypothesis.

In various embodiments, gates are generated based on a subject matter specific rulebase. For example, in the geological context, the rulebase may reflect relevant geological processes and scientific methods for gathering relevant data. The resulting detailed search Profile may contain multiple levels. Observed data (e.g., resulting from analysis of data collected in a targeting stage) are evaluated in relation to the gate combinations. The evaluation of the collection outcomes in relation to the completion of keys to open the gates, allows screening of non-viable profiles and allows focus on collection methods that are directed to filling gaps in the gates.

As an example, in the geological context, a rule may require a certain age range or texture of intrusive rocks in order to support the existence of an intrusion of interest. Such rules may vary by setting. For example, in one setting, age within a certain range may be sufficient. In another setting, supporting evidence in the form of neighboring alterations to the rock may be necessary.

Based on the rulesbase, all possible profiles that represent paths to the feature of interest are generated. In particular, given a feature of interest, all possible hypothetical scenarios are generated based on the rulebase.

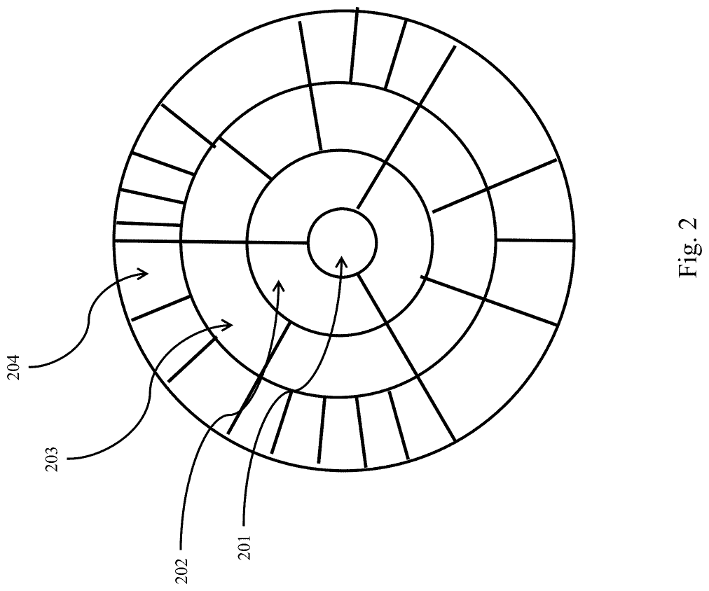

Each profile may be visualized as in FIG. 2. The feature of interest appears at center 201. The one or more factors necessary for that feature of interest form the first concentric ring 202 about the center. The one or more indicators associated with each Factor are given in the next concentric ring 203. The Manifestations associated with each indicator are given on the outer ring 204. Manifestations are stacked on the corresponding Indicators, which in turn are stacked on the corresponding Factors. This forms a tree structure corresponding the relationships of FIG. 1, as translated to a given set of rules.

For example, a set of profiles may describe the characteristics of a mineral deposit of interest, its elements (including Factors, Indicators, Manifestations, and Levels), and their relationship. In this case, each profile is a unique geologic model. The combination of geological features and associated quantifiable parameters supports target search.

In this geologic example, the Factors are critical geological processes that must have occurred to generate a mineralized system. The Indicators are geological features that are evidence for the existence of Factors. Because the way that an indicator appears in nature is effected by its environment, the possible manifestations of an indicator are defined as Manifestations. These Manifestations form a set of potential evidence that can be the actual expression of a particular indicator in a certain geological setting.

In some embodiments, the Manifestations in a set of profiles may be modified for a given setting. For example, a generic set of manifestations may initially be generated based on the rulebase. This set of manifestations may be screened based on the specific setting, removing those that are incompatible. In this way, the number of profiles (or number of viable hypotheses) is reduced, which in turn reduces the resources necessary for the search process. In some embodiments, one or more of the Manifestations is modified, for example by changing a numeric range or observed composition necessary for recognition of the Manifestation. In this way, a set of tailored profiles is generated for a given setting, for example a local geological context. The combinations that are valid for each area are different, so the number of viable profiles may vary from context to context.

Within each profile, each Manifestation includes a set of criteria necessary for a given observation to be considered a favorable manifestation according to that profile. For example, a given numeric range of a measurement or a given distance or direction of the Manifestation from an area of interest may be included. Each Manifestation may also include an associated probability of occurrence within a given setting.

A given profile includes a set of gate rules defining the relationships among the Manifestations, Indicators, and Factors. For example, a given Profile may define how many associated Indicators are required to conclude the existence of a given Factor. Likewise, a given profile may define how many associated Manifestations are required to conclude the existence of a given Indicator.

The aggregate decision points and criteria defined by a given permutation of the profiles may be referred to as Gates. Each Gate may be used to guide further evidence collection. With the collection of each new piece of information, the profiles in a set may be eliminated as viable hypotheses. At the same time, the further collection of evidence may be focused on those manifestations that are necessary to clear gates to arrive at a conclusion.

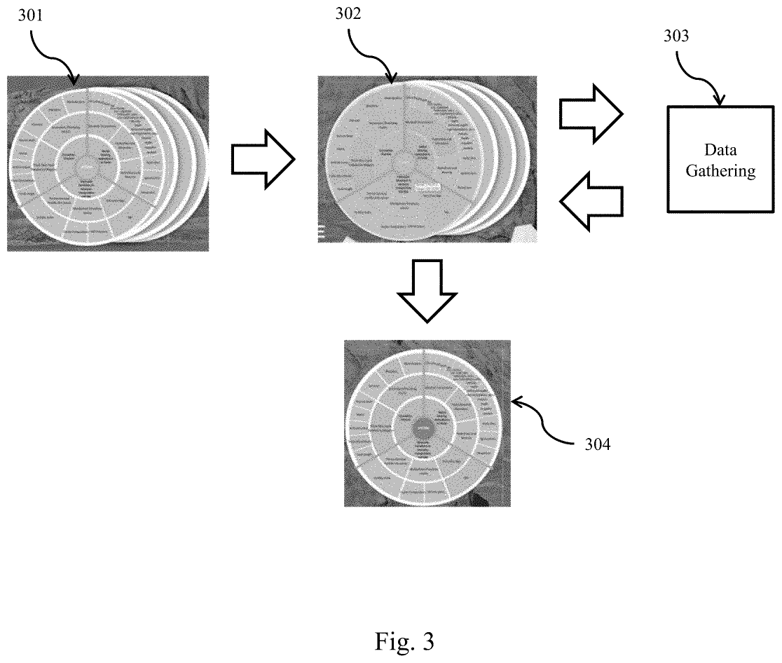

Referring to FIG. 3, the hypothesis testing process according to embodiments of the present disclosure is illustrated. At 301, a plurality of profile permutations is generated, corresponding to each hypothetical configuration that would lead to the determination of the presence of a hidden feature of interest. Each permutation may be referred to as a Gate. At 302, the available evidence is applied to the Gates. In this illustration, the observed manifestations are highlighted. Based on the gate rules, indicators are highlighted where their dependencies are met by the available evidence. In turn, the factors are satisfied where there dependencies are satisfied. Where the evidence supports completion of a given Gate, a Key is said to have been achieved. Those of the Gates that can no longer be met are discarded. Data gathering and analysis 303 may be conducted to fill in any gaps in the remaining viable Gates within the profile in order to progress to a determination of the presence of a hidden feature of interest. Once one or more Gates is satisfied, an accepted hypothesis 304 is provided for further action. Data gathering and culling of the viable profiles may repeat while there are remaining viable hypotheses.

The Gate rules taken in aggregate specify how to satisfy each element of the Profiles. For example, a given Factor may require at least 2 of its Indicators. Likewise, Gates define how many Manifestations and which types of Manifestations are required to be found in order to support the existence of each Indicator, and which Indicators are required to support the existence of Factor. The number of required Manifestations dictates the total number of possible combinations.

Manifestations, Indicators, and Factors are not equally crucial for the completion of a Key and in order to conclude the existence of a hidden feature. Some of these elements are always necessary, others are optional, and some are merely supportive but not sufficient. The relative value of these elements is expressed in the Gate Rules as follows:
Necessary: The element is indispensable for the minimum combinations of Manifestations and should appear in any Gate;
Complementary: The element should be part of the needed Manifestation combinations, however it is not indispensable, as there are other complementary elements and any of them can also complete the need of the element;
Optional: The element is not enough to complete any requirement of the need, so it is only an optional Manifestation that will eventually influence on the ranking of the gate.

As described above, the potential minimum combinations of Manifestations necessary to conclude the existence of a feature of interest may be referred to as Gates. The Gate criteria combinations are pre-generated based on the Profile and the gate rules. A gate represents the minimum necessary to conclude the presence of a feature of interest. Additional evidence may provide additional confidence in the conclusion, as set forth below.

In some embodiments, each Manifestation is assigned a Power rating that is suitable for the particular domain. The Power may then be aggregated for each permutation within the profile, allowing each permutation to be ranked based on accumulated power. In this way, the relative strength of each specific combination of Manifestations may be determined. Assessing the contribution of a given Manifestations to the identification of a given hidden feature allows information gathering to be prioritized to arrive at a high-confidence determination of the presence of a hidden feature. In some embodiments, the power of a gate is determined by summing the power of its Manifestations.

In various embodiments, the Manifestations Power provides a quantitative value representing the importance of a Manifestation to the determination of a given feature of interest. This value is based on the contribution of the Manifestation, both in terms of determine of presence and in terms of the quality of the hidden feature. For example, in a geological context, it may provide a weight indicative both of the predictive power of the Manifestation and of the likely commercial potential of a target. In some embodiments, the total Power of each Manifestation comprises a standard power and an additional power adjustment to a given domain. In some embodiments, the power score varies from 0 (doesn't contribute at all) to 3 (highest contribution). In some embodiments, the power score varies from 0 (doesn't contribute at all) to 9 (highest contribution). In some embodiments, the weighted average of multiple quantitative factors may be taken to arrive at the final power score.

It will be appreciated that a variety of rubrics may be applied to determine a power score, depending on the application area, and the specific needs of a given domain. For example, in the geological context, power scores may be set manually based on the domain's setting and it's geological context.

In various embodiments, all relevant evidence is evaluated according to evidence quality thresholds. The quality thresholds ensure that the information of the Manifestation occurrence has a sufficient level of quality, on a predefined scale. Quality thresholds may related to the confidence in the measurement technique, or trustworthiness of data. Similarly, quality thresholds may relate to the spatial layout of the various manifestations, thereby ensuring that the observations are indicative and not merely random. Taken together, these factors enable a determination of reliability of the input data. This guarantees that the a minimum level of information quality that before a Manifestation is said to be present. A quality score is assigned to a certain Manifestation occurrence. In the geological context, the input evidence may be occurrences of geological features around an anchor point.

In various embodiments, as evidence is evaluated against a given gate configuration, the Manifestation is tested to ensure that the occurrence fits the value or range that was defined for it in the rulebase. This provides a specification of the minimum technical requirements Manifestation to validate the presence of the Manifestation.

In various embodiments, additional filters are imposed on observed evidence. For example, a geographic screen may be imposed, where observed data is only counted towards satisfaction of a Manifestation where its collection point conforms to a geospatial relationship. For example, a maximum geographic distance between a Manifestation's occurrence and an anchor point can imply relation to the same geological system.

As the top ranked gates are compared to the available evidence, a prioritized list of evidentiary gaps is determined. In particular, where a gate has a potentially high power score, but is missing evidence to complete it, that missing evidence may be prioritized for collection over the evidence for lower-valued gates.

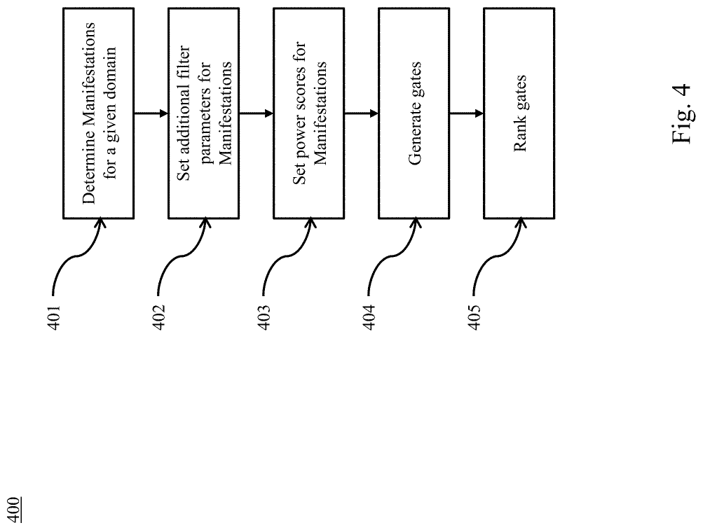

With reference now to FIG. 4, a process for preparing gates for detection of a hidden feature of interest is illustrated according to embodiments of the present disclosure. At 401, a plurality of manifestations is determined for a given domain. In some embodiments, the domain corresponds to a particular subject matter. In some embodiments, the domain corresponds to a particular geological setting. At 402, additional filter parameters are set for the Manifestations. In some embodiments, the filter parameters include an observed range, a confidence score, or a distance. At 403, a power score is assigned to each manifestation. In some embodiments, the power score indicates the favorability of the manifestation towards the hidden feature of interest. At 404, a plurality of gates is generated based on the Manifestation. In some embodiments, the Gates reflect rules connecting the Manifestations to the hidden feature of interest.

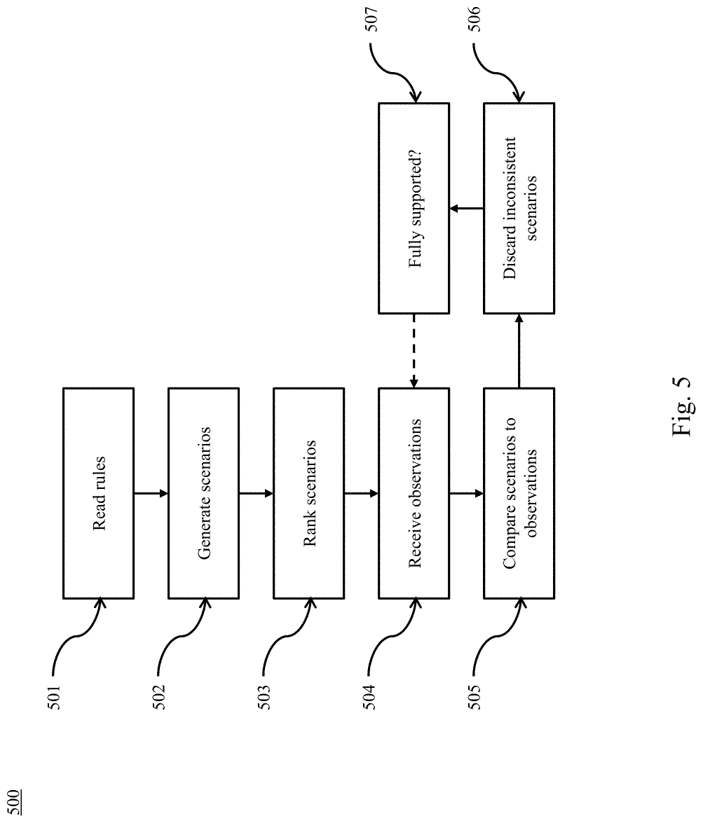

With reference now to FIG. 5, a process for preparing gates for detection of a hidden feature of interest is illustrated according to embodiments of the present disclosure. At 501, a plurality of rules is read. The rules relate a plurality of observable phenomena to a hidden feature of interest. At 502, a plurality of scenarios is generated based on the feature of interest and the plurality of rules. Each scenario specifies a combination of observations sufficient to indicate the hidden feature of interest. At 503, the plurality of scenarios is ranked based on a score associated with each of the observations. At 504, a plurality of observations is received. At 505, the plurality of scenarios is compared to the plurality of observations. At 506, those of the plurality of scenarios inconsistent with the plurality of observations are discarded. At 507, additional observations are received until at least one of the plurality of scenarios is fully supported by the observations.

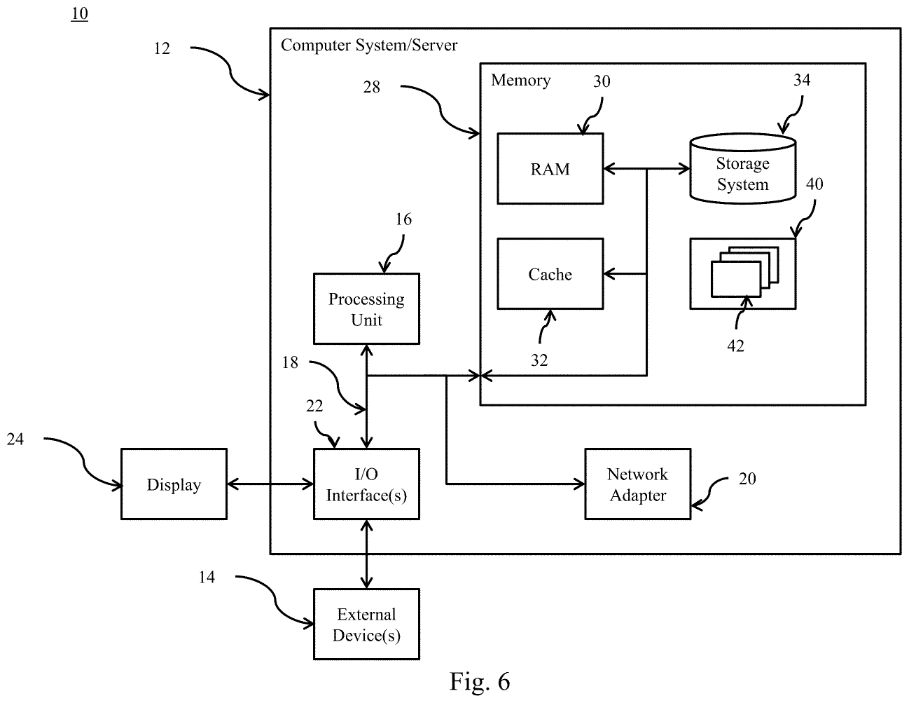

Referring now to FIG. 6, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
reading a plurality of rules, the rules relating a plurality of observable phenomena to a hidden feature of interest;
based on the feature of interest and the plurality of rules, generating a plurality of possible hypothetical scenarios, each hypothetical scenario specifying a combination of observations sufficient to indicate presence of the hidden feature of interest;
ranking the plurality of hypothetical scenarios based on a score associated with each of the observations;
receiving a plurality of observations, and thereupon
comparing the plurality of hypothetical scenarios to the plurality of observations,
discarding those of the plurality of hypothetical scenarios inconsistent with the plurality of observations, and
receiving additional observations until at least one of the plurality of hypothetical scenarios is fully supported, thereby validating the at least one of the plurality of hypothetical scenarios.

2. The method of claim 1, wherein the plurality of rules relates the plurality of observable phenomena to the feature of interest via one or more hidden processes.

3. The method of claim 1, wherein the score associated with each of the observations indicates a degree of contribution to a detection of the feature of interest.

4. The method of claim 3, wherein the score further indicates a confidence level in the presence of the feature of interest.

5. The method of claim 4, wherein the score further indicates a relative cost of gathering further observations.

6. The method of claim 1, further comprising outputting a detection of the feature of interest.

7. The method of claim 1, wherein comparing the plurality of scenarios to the plurality of observations comprises applying one or more filters to the plurality of observations.

8. The method of claim 1, wherein comparing the plurality of scenarios to the plurality of observations comprises determining whether a minimum number of observations have been received to indicate a hidden feature.

9. The method of claim 1, wherein each scenario further specifies an associated confidence level.

10. The method of claim 1, wherein each scenario further specifies an associated favorability.

11. A system comprising:
a computing node comprising a computer readable storage medium having program instructions embodied therewith, the program instructions executable by a processor of the computing node to cause the processor to perform a method comprising:
reading a plurality of rules, the rules relating a plurality of observable phenomena to a hidden feature of interest;
based on the feature of interest and the plurality of rules, generating a plurality of possible hypothetical scenarios, each hypothetical scenario specifying a combination of observations sufficient to indicate the hidden feature of interest;
ranking the plurality of hypothetical scenarios based on a score associated with each of the observations;
receiving a plurality of observations, and thereupon
comparing the plurality of hypothetical scenarios to the plurality of observations,
discarding those of the plurality of hypothetical scenarios inconsistent with the plurality of observations, and
receiving additional observations until at least one of the plurality of hypothetical scenarios is fully supported, thereby validating the at least one of the plurality of hypothetical scenarios.

12. The system of claim 11, wherein the plurality of rules relates the plurality of observable phenomena to the feature of interest via one or more hidden processes.

13. The system of claim 11, wherein the score associated with each of the observations indicates a degree of contribution to a detection of the feature of interest.

14. The system of claim 13, wherein the score further indicates a confidence level in the presence of the feature of interest.

15. The system of claim 14, wherein the score further indicates a relative cost of gathering further observations.

16. The system of claim 11, further comprising outputting a detection of the feature of interest.

17. The system of claim 11, wherein comparing the plurality of scenarios to the plurality of observations comprises applying one or more filters to the plurality of observations.

18. The system of claim 11, wherein comparing the plurality of scenarios to the plurality of observations comprises determining whether a minimum number of observations have been received to indicate a hidden feature.

19. The system of claim 11, wherein each scenario further specifies an associated confidence level.

20. The system of claim 11, wherein each scenario further specifies an associated favorability.

21. A computer program product for detection of a hidden feature of interest, the computer program product comprising a computer readable storage medium having program instructions embodied therewith, the program instructions executable by a processor to cause the processor to perform a method comprising:
reading a plurality of rules, the rules relating a plurality of observable phenomena to a hidden feature of interest;
based on the feature of interest and the plurality of rules, generating a plurality of hypothetical scenarios, each hypothetical scenario specifying a combination of observations sufficient to indicate the hidden feature of interest;
ranking the plurality of possible hypothetical scenarios based on a score associated with each of the observations;
receiving a plurality of observations, and thereupon comparing the plurality of hypothetical scenarios to the plurality of observations,
discarding those of the plurality of hypothetical scenarios inconsistent with the plurality of observations, and
receiving additional observations until at least one of the plurality of hypothetical scenarios is fully supported, thereby validating the at least one of the plurality of hypothetical scenarios.

22. The computer program product of claim 21, wherein the plurality of rules relates the plurality of observable phenomena to the feature of interest via one or more hidden processes.

23. The computer program product of claim 21, wherein the score associated with each of the observations indicates a degree of contribution to a detection of the feature of interest.

24. The computer program product of claim 23, wherein the score further indicates a confidence level in the presence of the feature of interest.

25. The computer program product of claim 24, wherein the score further indicates a relative cost of gathering further observations.

26. The computer program product of claim 21, further comprising outputting a detection of the feature of interest.

27. The computer program product of claim 21, wherein comparing the plurality of scenarios to the plurality of observations comprises applying one or more filters to the plurality of observations.

28. The computer program product of claim 21, wherein comparing the plurality of scenarios to the plurality of observations comprises determining whether a minimum number of observations have been received to indicate a hidden feature.

29. The computer program product of claim 21, wherein each scenario further specifies an associated confidence level.

30. The computer program product of claim 21, wherein each scenario further specifies an associated favorability.
